(19) United States
(12) Patent Application Publication
(10) Pub. No.: US 2026/0213274 A1
(43) Pub. Date: Jul. 23, 2026

(54) ALL-SOLID-STATE BATTERY AND METHOD FOR MANUFACTURING SAME

(71) Applicant: Maxell, Ltd., Otokuni-gun (JP)

(72) Inventor: Haruki Kamizori, Otokuni-gun (JP)

(73) Assignee: Maxell, Ltd., Otokuni-gun (JP)

(21) Appl. No.: 19/409,938

(22) Filed: Dec. 5, 2025

Related U.S. Application Data
(63) Continuation-in-part of application No. PCT/JP2024/020301, filed on Jun. 4, 2024.

(30) Foreign Application Priority Data
Jun. 5, 2023 (JP) 2023-092577

(51) Int. Cl. H01M 10/0585; H01M 4/02; H01M 4/04; H01M 4/525; H01M 4/58; H01M 10/04; H01M 10/0562

(52) U.S. Cl. CPC H01M 10/0585; H01M 4/0433; H01M 4/525; H01M 4/5825; H01M 10/0427; H01M 10/0562; H01M 2004/021; H01M 2300/0068

(57) ABSTRACT

The all-solid-state battery includes an electrode body formed by stacking a positive electrode and a negative electrode with a solid electrolyte layer interposed therebetween. The solid electrolyte layer is a stack of: a solid electrolyte layer (I) including a porous substrate and having a portion protruding from an end portion of the positive electrode and the negative electrode in a plan view; a solid electrolyte layer (II) bonded to the positive electrode and having a smaller area than that of the solid electrolyte layer (I) in a plan view; and a solid electrolyte layer (III) bonded to the negative electrode and having a smaller area than that of the solid electrolyte layer (I) in a plan view. At least one of (II) and (III) is different from (I).

### TECHNICAL FIELD

The present invention relates to an all-solid-state battery having excellent reliability, and a method for producing the same.

### BACKGROUND ART

In recent years, the development of portable electronic devices such as cellular phones and laptop personal computers, the practical use of electric vehicles, and the like have led to the need for compact and lightweight batteries that have a high capacity and a high energy density.

Currently, in lithium batteries, especially lithium-ion batteries, that can meet this demand, a lithium-containing composite oxide such as lithium cobalt oxide (LiCoO₂) or lithium nickel oxide (LiNiO₂) is used as a positive electrode active material, graphite or the like is used as a negative electrode active material, and an organic electrolyte solution containing an organic solvent and a lithium salt is used as a nonaqueous electrolyte.

Due to further development of devices that use lithium-ion batteries, there is a demand for lithium-ion batteries having an increased life-span, a higher capacity, and a higher energy density, and a high degree of reliability is also required for the lithium-ion batteries having an increased life-span, a higher capacity, and a higher energy density.

However, since an organic electrolyte solution used in a lithium-ion battery contains a flammable organic solvent, the organic electrolyte solution may abnormally generate heat when an abnormal situation such as a short circuit occurs in the battery. In recent years, as the energy density of lithium-ion batteries and the amount of organic solvent in the organic electrolyte solution have increased, there is growing need for reliability in lithium-ion batteries.

Under these circumstances, all-solid-state lithium batteries (all-solid-state batteries) without using organic solvents have been considered. An all-solid-state lithium battery includes, instead of conventional organic solvent-based electrolytes, a molded body made of a solid electrolyte in which no organic solvents are used, and it is highly reliable because there is no risk of the solid electrolyte abnormally generating heat. Therefore, in particular, there are great expectations for all-solid-state lithium batteries in product areas in which high-capacity secondary batteries are required.

Also, all-solid-state batteries are very safe as well as being highly reliable and highly environmentally resistant, and they have an increased life-span. Therefore, it is anticipated that all-solid-state batteries will become maintenance-free batteries that can continue to contribute to the development of society, as well as to safety and security. Providing all-solid-state batteries to society will contribute to reaching the following goals of the 17 Sustainable Development Goals (SDGs) established by the United Nations: Goal 3 (to ensure healthy lives and promote well-being for all people of all ages), Goal 7 (to ensure access for all people to affordable, reliable, sustainable and modern energy), Goal 11 (to achieve inclusive, safe, resilient and sustainable cities and human settlements), and Goal 12 (to ensure sustainable production and consumption patterns).

Further, various studies have been carried out on all-solid-state batteries as well. For example, to solve issues such as a short circuit caused by the development of adhesiveness in an electrolyte in a secondary battery having an electrolyte with low fluidity such as a solid electrolyte, Patent Document 1 proposes a structure for a secondary battery in which an insulating layer interposed between a positive electrode layer and a negative electrode layer is constituted by an electrolyte layer and a polymer-rich layer having a larger amount of polymer than the electrolyte layer, and the electrolyte layer is disposed on each of the positive electrode layer side and the negative electrode layer side.

In addition, Patent Documents 2 to 5 propose that a solid electrolyte sheet having both lithium-ion conductivity and strength is obtained by filling pores of a substrate made of a porous substrate such as a nonwoven fabric with a solid electrolyte, and that an all-solid-state secondary battery is formed using this solid electrolyte sheet.

Among them, Patent Document 5 discloses that the mechanical strength of a solid electrolyte sheet can be improved by setting the thickness of the porous substrate to 70% or more of the thickness of the entire solid electrolyte sheet, and that even when the area of the solid electrolyte sheet is increased, it is possible to prevent damage to the solid electrolyte and the solid electrolyte from falling from the porous substrate.

### PRIOR ART DOCUMENTS

### Patent Document

[Patent Document 1] JP 2019-16573 A
[Patent Document 2] JP 2015-153460 A
[Patent Document 3] JP 2016-139482 A
[Patent Document 4] WO 2019/208347
[Patent Document 5] WO 2020/054081

### SUMMARY OF INVENTION

### Technical Problem

With the technique described in Patent Document 5, it is possible to increase the size of the all-solid-state battery, thereby achieving higher capacity, for example. However, when a positive electrode having a positive electrode mixture layer containing a positive electrode active material or a negative electrode having a negative electrode mixture layer containing a negative electrode active material is integrated with a solid electrolyte sheet having a porous substrate by, for example, compression molding, the solid electrolyte sheet may crack to cause a short circuit of the battery, or the solid electrolyte sheet may be insufficiently bonded to the positive electrode or the negative electrode to peel off from the positive electrode or the negative electrode. Accordingly, in the all-solid-state battery having the solid electrolyte sheet as the solid electrolyte layer, it is required to develop a technique for suppressing the occurrence of the above-described issues and improving the reliability.

The present invention has been made in view of the above-described circumstances, and aims to provide a highly reliable all-solid-state battery, and a method for producing the same.

### Solution to Problem

An aspect of the all-solid-state battery of the present invention includes an electrode body formed by stacking a positive electrode and a negative electrode with a solid electrolyte layer interposed therebetween, in which the solid electrolyte layer is a stack including: a solid electrolyte layer (I) including a porous substrate and having a portion protruding from end portions of the positive electrode and the negative electrode in a plan view; a solid electrolyte layer (II) bonded to the positive electrode and having a smaller area than an area of the solid electrolyte layer (I) in a plan view; and a solid electrolyte layer (III) bonded to the negative electrode and having a smaller area than the area of the solid electrolyte layer (I) in a plan view, at least one of a solid electrolyte of the solid electrolyte layer (II) and a solid electrolyte of the solid electrolyte layer (III) is different from a solid electrolyte of the solid electrolyte layer (I), and the protruding portion of the solid electrolyte layer (I) has a width of 1 μm to 1 mm.

An aspect of the method for producing an all-solid-state battery of the present invention is a method for producing an all-solid-state battery including an electrode body formed by stacking a positive electrode and a negative electrode with a solid electrolyte layer interposed therebetween, the solid electrolyte layer being a stack of a solid electrolyte layer (I) having a porous substrate, a solid electrolyte layer (II) bonded to the positive electrode, and a solid electrolyte layer (III) bonded to the negative electrode, at least one of a solid electrolyte of the solid electrolyte layer (II) and a solid electrolyte of the solid electrolyte layer (III) being different from a solid electrolyte of the solid electrolyte layer (I), the method including: preparing a solid electrolyte sheet including a porous substrate and a solid electrolyte held in the porous substrate; preparing a positive electrode having one surface covered with a solid electrolyte; preparing a negative electrode having one surface covered with a solid electrolyte; bonding the positive electrode to one surface of the solid electrolyte sheet in such a manner that the solid electrolyte covering the positive electrode is in contact with the one surface of the solid electrolyte sheet; and bonding the negative electrode to the other surface of the solid electrolyte sheet in such a manner that the solid electrolyte covering the negative electrode is in contact with the other surface of the solid electrolyte sheet, in which the solid electrolyte sheet, the solid electrolyte covering the positive electrode, and the solid electrolyte covering the negative electrode are pressurized to form the solid electrolyte layer in such a manner that an outer periphery of an end portion of the solid electrolyte layer (I) protrudes from an end portion of the positive electrode or the negative electrode by 1 μm to 1 mm in a plan view.

### Advantageous Effects of Invention

According to the present invention, it is possible to provide a highly reliable all-solid-state battery and a method for producing the same.

### BRIEF DESCRIPTION OF DRAWINGS

FIG. 1 is a cross-sectional view schematically showing an example of an all-solid-state battery according to the present invention.

### DESCRIPTION OF EMBODIMENTS

The all-solid-state battery of the present invention has an electrode body formed by stacking a positive electrode and a negative electrode with a solid electrolyte layer interposed therebetween. The solid electrolyte layer has the following solid electrolyte layer (I), solid electrolyte layer (II), and solid electrolyte layer (III), and is constituted by stacking these three layers.

The solid electrolyte layer (I) has a porous substrate and has a portion protruding from end portions of the positive electrode and the negative electrode in a plan view. The solid electrolyte layer (II) is bonded to the positive electrode and has an area smaller than that of the solid electrolyte layer (I) in a plan view, and the solid electrolyte layer (III) is bonded to the negative electrode and has an area smaller than that of the solid electrolyte layer (I) in a plan view.

In addition, at least one of a solid electrolyte of the solid electrolyte layer (II) and a solid electrolyte of the solid electrolyte layer (III) is different from a solid electrolyte of the solid electrolyte layer (I), and the width of the protruding portion of the solid electrolyte layer (I) is preferably set in a range of 1 μm to 1 mm.

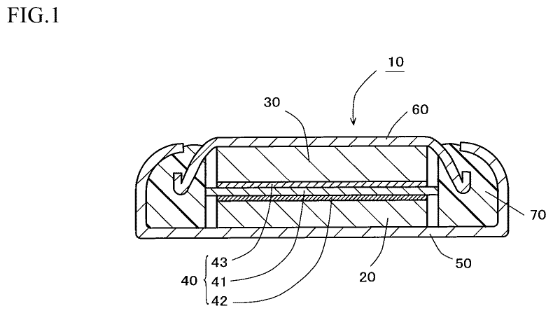

FIG. 1 is a cross-sectional view schematically showing an example of the all-solid-state battery according to the present invention. A battery 10 shown in FIG. 1 includes an exterior body constituted by an exterior can 50, a sealing can 60, and a resin gasket 70 interposed between these cans, and a positive electrode 20, a negative electrode 30, and a solid electrolyte layer 40 interposed between the positive electrode 20 and the negative electrode 30 are enclosed in the exterior body.

The sealing can 60 is fitted into an opening of the exterior can 50 via the gasket 70, and an opening end of the exterior can 50 is tightened inward, which causes the gasket 70 to abut against the sealing can 60, thereby sealing the opening of the exterior can 50 and creating an airtight structure inside the battery.

The exterior can and the sealing can may be made of, e.g., stainless steel. The gasket may be made of, e.g., polypropylene or nylon. When heat resistance is required in relation to the intended use of a battery, the gasket may also be made of heat-resistant resin with a melting point of more than 240° C. Examples of the heat resistance resin include: fluororesins such as a tetrafluoroethylene-perfluoroalkoxyethylene copolymer (PFA); polyphenylene ether (PPE); polysulfone (PSF); polyarylate (PAR); polyether sulfone (PES); polyphenylene sulfide (PPS); and polyetheretherketone (PEEK). Moreover, when the battery is used for applications requiring heat resistance, the exterior body can be sealed by a glass hermetic seal.

The solid electrolyte layer 40 includes a solid electrolyte layer (I) 41 having a porous substrate, a solid electrolyte layer (II) 42 bonded to the positive electrode 20, and a solid electrolyte layer (III) 43 bonded to the negative electrode 30.

As described above, when the solid electrolyte sheet having the porous substrate is used to form the electrode body, if the solid electrolyte sheet is bonded to the positive electrode or the negative electrode by compression molding, the bonding between the solid electrolyte sheet and the positive electrode (a molded body of a positive electrode mixture containing a positive electrode active material or a positive electrode mixture layer) and between the solid electrolyte sheet and the negative electrode (a molded body of a negative electrode mixture containing a negative electrode active material or a negative electrode mixture layer) may be insufficient, or the solid electrolyte sheet may be cracked.

However, as shown in FIG. 1, in a case where the solid electrolyte layer included in the electrode body is configured to include the solid electrolyte layer (I) containing a porous substrate, and the solid electrolyte layer (II) disposed on a surface of the solid electrolyte layer (I) and the solid electrolyte layer (III) disposed on the other surface of the solid electrolyte layer (I), for example, the electrode body can be formed by using a positive electrode in which a covering layer of a solid electrolyte is formed in advance on a surface of a molded body of a positive electrode mixture (positive electrode mixture layer) on the solid electrolyte layer (I) side, and a negative electrode in which a covering layer of a solid electrolyte is formed in advance on a surface of a molded body of a negative electrode mixture (negative electrode mixture layer) on the solid electrolyte layer (I) side, and performing compression molding with each of these covering layers on the solid electrolyte layer (1) side. In this manner, the solid electrolyte layer (II) and the solid electrolyte layer (III) are favorably bonded to the solid electrolyte layer (I), and it is possible to avoid application of an excessive pressure to the solid electrolyte layer (I) (solid electrolyte sheet) during pressurization at the time of forming the electrode body. Thus, it is possible to favorably suppress the decrease in battery characteristics due to peeling of the solid electrolyte layer from the positive electrode and the negative electrode during the production or use of the all-solid-state battery, and the occurrence of a short circuit due to the cracking of the solid electrolyte layer (solid electrolyte sheet). This allows the all-solid-state battery of the present invention to have excellent reliability, and can also increase productivity.

Note that as shown in FIG. 1, in the solid electrolyte layer of the all-solid-state battery, it is preferable that the outer periphery of the solid electrolyte layer (1) protrudes from the end portions of the positive electrode and the negative electrode in a plan view of the electrode body (when viewed from above or below in FIG. 1), and the solid electrolyte layer (II) and the solid electrolyte layer (III) each have a smaller area than that of the solid electrolyte layer (I) in a plan view. With such a configuration, the solid electrolyte layer (II) can have an area equivalent to that of the molded body of the positive electrode mixture of the positive electrode (positive electrode mixture layer), and the solid electrolyte layer (III) can have an area equivalent to that of the molded body of the negative electrode mixture of the negative electrode (negative electrode mixture layer). That is, the size of the solid electrolyte layer (II) can be the same as that of the positive electrode (positive electrode mixture layer), and the size of the solid electrolyte layer (III) can be the same as that of the negative electrode (negative electrode mixture layer). Accordingly, for example, the molded body of the positive electrode mixture (positive electrode mixture layer) and the solid electrolyte layer (II), and the molded body of the negative electrode mixture (negative electrode mixture layer) and the solid electrolyte layer (III) can be formed using a common mold (such as a metal mold), respectively, while even when the positive electrode and the negative electrode are misaligned during assembly, the contact between the positive electrode and the negative electrode can be favorably prevented by the solid electrolyte layer (I) having a large area. Thus, the all-solid-state battery of the present invention can also improve the productivity and reliability by such an action. Note that the outer periphery of the solid electrolyte layer (I) preferably protrudes from the end portions of the positive electrode and the negative electrode over the entire circumference. That is, it is preferable that the portion of the solid electrolyte layer (I) protruding from the end portions of the positive electrode and the negative electrode is formed in a ring shape.

Next, details of each component of the all-solid-state battery of the present invention will be described. Note that the all-solid-state battery of the present invention includes a primary battery and a secondary battery.

### <Solid Electrolyte Layer>

### [Solid Electrolyte Layer (I)]

The solid electrolyte layer (I) has a porous substrate, and at least a portion of the solid electrolyte constituting the solid electrolyte layer (I) is present in a state of being held inside the porous substrate.

The solid electrolyte layer (I) can be formed by using a solid electrolyte sheet obtained by filling the inside of the porous substrate with the solid electrolyte.

The porous substrate of the solid electrolyte sheet may be made of a fibrous article, such as woven fabric, nonwoven fabric, or mesh, with nonwoven fabric being particularly preferable.

The fiber diameter of a fibrous article that constitutes the porous substrate is preferably 5 μm or less, and preferably 0.5 μm or more.

There is no particular limitation on the material of the fibrous article as long as it does not react with metallic lithium and has insulating properties. It is possible to use resins such as polyolefins (e.g., polypropylene and polyethylene); polystyrene; aramid; polyamide-imide; polyimide; nylon; polyesters such as polyethylene terephthalate (PET); polyarylate; cellulose and modified cellulose, and the like. Further, inorganic materials such as glass, alumina, silica, and zirconia may also be used. A preferable material is polyarylate. The fibrous article may be made of one or two or more of the materials listed above. Further, the porous substrate may be constituted by only fibrous articles made of the same material, or may be constituted by fibrous articles made of two or more different materials.

The weight per area of the porous substrate is preferably 10 g/m² or less, and more preferably 8 g/m² or less such that a sufficient amount of the solid electrolyte can be retained so as to be able to ensure favorable lithium-ion conductivity and a favorable function of suppressing the growth of lithium dendrites, and is preferably 3 g/m² or more, and more preferably 4 g/m² or more from the viewpoint of ensuring sufficient strength.

The solid electrolyte contained in the solid electrolyte sheet is not particularly limited as long as it has lithium-ion conductivity, and for example, a sulfide-based solid electrolyte, a hydride-based solid electrolyte, a halide-based solid electrolyte, an oxide-based solid electrolyte, or the like can be used.

The solid electrolyte layer (I) of the solid electrolyte layer can contain the solid electrolyte 1, which reacts with metallic lithium to oxidize lithium, and the solid electrolyte contains at least one element selected from Ti, Ge, Sn, Al and Si. Specific examples of such solid electrolytes include La_{0.05}Li_{0.35}TiO₃ (LLTO), Li_{1.5}Al_{0.5}Ge_{1.5}(PO₄)₃ (LAGP), Li₁₀SnP₂S₁₂ (LSPS), Li_{1.4}Al_{0.5}Ti_{1.6}(PO₄)₃ (LATP), Li₁₀GeP₂S₁₂ (LGPS), and Li₂O—Al₂O₃—SiO₂—P₂O₅—TiO₂.

At least one of the solid electrolyte layer (II) or the solid electrolyte layer (III) can contain, separately from the solid electrolyte layer (I), a solid electrolyte 2 having a lower reactivity with metallic lithium than the solid electrolyte layer (I). The solid electrolyte 2 contained in the solid electrolyte layer (II) or (III) is not particularly limited as long as it has little or no action of oxidizing lithium by reacting with metallic lithium and has lithium-ion conductivity, and for example, a sulfide-based solid electrolyte, a hydride-based solid electrolyte, a halide-based solid electrolyte, or the like can be used. Examples of the sulfide-based solid electrolyte include a solid electrolyte having an argyrodite-type structure. The solid electrolyte 2 of the solid electrolyte layer (II) or (III) may be made only of the solid electrolyte 2, but may contain the solid electrolyte 1 within a range not inhibiting the battery reaction.

According to the above configuration, while efficiently suppressing the growth of lithium dendrites in the solid electrolyte layer (I), good lithium-ion conductivity can be ensured by the solid electrolyte layer (II) or (III). Thus, good battery characteristics can be ensured, and the occurrence of a short circuit due to lithium dendrites can be suppressed, which can enhance the reliability.

Examples of the sulfide-based solid electrolytes include particles of Li₂S—P₂S₅-based glass, Li₂S—SiS₂-based glass, Li₂S—P₂S₅—GeS₂-based glass, Li₂S—B₂S₃-based glass, or the like. In addition, it is possible to use sulfide-based solid electrolytes having a thio-LISICON-type structure (Li_{12-12a-b+c+6d-e}M¹_{3+a-b-c-d}M²_{b}M³_{c}M⁴_{d}M⁵₁₂₋ₑXₑ (where M¹ is Si, Ge, or Sn, M² is P or V, M³ is Al, Ga, Y, or Sb, M⁴ is Zn, Ca, or Ba, M⁵ is S or one of S and O, X is F, Cl, Br, or I, and a, b, c, d, and e satisfy 0≤a<3, 0≤b+c+d≤3, and 0≤e≤3), such as Li₁₀GeP₂S₁₂, Li_{9.54}Si_{1.74}P_{1.44}S_{11.7}Cl_{0.3}), or an argyrodite-type structure (Li₇₋ₖPS₆₋ₖXₖ (where X represents one or more types of halogen elements and k satisfies 0.2<k<2.0, such as Li₆PS₅Cl), Li_{7-f+g}PS_{6-f}Cl_{f+g} (where f and g satisfy 0.05≤f≤0.9, and −3.0+1.8≤g≤−3.0f+5.7)), and Li₇₋ₕPS₆₋ₕClᵢBrⱼ (where h, i, and j satisfy h=i+j, 0<h≤1.8, and 0.1≤i/j≤10.0)), which have attracted attention in recent years due to their high lithium-ion conductivity.

Examples of the hydride-based solid electrolytes include LiBH₄, and solid solutions of LiBH₄ and a following alkali metal compound (e.g., solid solutions in which the mole ratio between LiBH₄ and the alkali metal compound is 1:1 to 20:1). At least one selected from the group consisting of lithium halides (e.g., LiI, LiBr, LiF, and LiCl), rubidium halides (e.g., RbI, RbBr, RbF, and RbCl), cesium halides (e.g., CsI, CsBr, CsF, and CsCl), lithium amides, rubidium amides, and cesium amides can be used as the alkali metal compound in the above-mentioned solid solution.

Examples of the halide-based solid electrolytes include monoclinic LiAlCl₄, defect spinel or layered LiInBr₄, and monoclinic Li₆₋₃ₘYₘX₆ (where m satisfies 0<m<2 and X=Cl or Br), and it is possible to use known solid electrolytes disclosed in WO 2020/070958 and WO 2020/070955, and the like.

Examples of the oxide-based solid electrolyte include garnet-type Li₇La₃Zr₂O₁₂, and NASICON-type Li_{1+O}Al_{1+O}Ti_{2-O}(PO₄)₃, Li₁₊ₚAl₁₊ₚGe₂₋ₚ(PO₄)₃, and perovskite-type Li_{3q}La_{2/3-q}TiO₃.

As the solid electrolyte, the solid electrolytes listed above may be used alone or in combination of two or more. Among these solid electrolytes, sulfide-based solid electrolytes are preferable because sulfide-based solid electrolytes have high lithium-ion conductivity, sulfide-based solid electrolytes containing Li and P are more preferable, and in particular, sulfide-based solid electrolytes having an argyrodite-type structure and having high lithium-ion conductivity and high chemical stability are even more preferable.

The solid electrolyte is preferably in the form of particles, and the particles have an average particle size of preferably 5 μm or less, and more preferably 2 μm or less, from the viewpoint of further improving the ability to fill pores of the porous substrate, and ensuring favorable lithium-ion conductivity, the function of suppressing the growth of lithium dendrites, and the like. Note that if the solid electrolyte particles are too small, there is a risk that handleability will deteriorate. Also, as will be described later, the solid electrolyte particles are preferably bound using a binder in order to retain the particles in the pores of the porous substrate or to make the particles adhere well to the surface of the porous substrate. However, depending on the case, a large amount of binder may be required and the resistance value may increase. Therefore, the average particle diameter of the solid electrolyte particles is preferably 0.3 μm or more, and more preferably 0.5 μm or more.

The average particle diameter of solid electrolyte particles used in this specification and other particles (a positive electrode active material, a negative electrode active material or the like) refers to the value of the 50% diameter (D₅₀) in a volume-based integrated fraction when the integrated volume is calculated based on particles with a small particle size, using a particle size distribution measuring device (Microtrac particle size analyzer “HRA9320” manufactured by Nikkiso Co., Ltd., etc.).

The end portion of the porous substrate may be exposed on the surface of the solid electrolyte sheet, but in this case, the solid electrolyte is desirably exposed together with the end portion of the porous substrate to more smoothly move lithium ions between the positive electrode and the negative electrode. The surface of the solid electrolyte sheet and the vicinity thereof may be made only of the solid electrolyte (and a binder and the like described below) without the porous substrate.

It is preferable to bind the solid electrolyte using a binder in order to increase the shape retention of the solid electrolyte sheet and improve the adhesion to the solid electrolyte layer (II) and the solid electrolyte layer (III) by favorably retaining the solid electrolyte in pores of the porous substrate, or improving the adhesion of the solid electrolyte covering the surface of the porous substrate to the porous substrate in the solid electrolyte sheet.

The binder for the solid electrolyte sheet is desirably a binder that does not react with the solid electrolyte, and at least one resin selected from the group consisting of butyl rubber, chloropyrene rubber, acrylic resin, and fluororesin is preferably used.

Also, the thickness of the solid electrolyte sheet is preferably 5 μm or more and more preferably 10 μm or more, and is preferably 50 μm or less, and more preferably 30 μm or less, from the viewpoint of optimizing the distance between the positive electrode and the negative electrode of a battery in which the solid electrolyte sheet is used, and suppressing the occurrence of short-circuiting and an increase in resistance.

When the solid electrolyte covering the surface of the porous substrate has the thickness as described above, the thickness of the porous substrate in the solid electrolyte sheet is preferably 85% or less of the thickness of the solid electrolyte sheet, and more preferably 80% or less thereof, from the viewpoint of ensuring a better effect of suppressing lithium dendrite deposition that causes charging abnormalities, in addition to smoothing the movement of lithium ions on the positive electrode side and smoothing the movement of lithium ions on the negative electrode side.

Note that the porous substrate functions as a component for improving the shape retention of the solid electrolyte sheet. When the thickness ratio of the porous substrate to the solid electrolyte sheet is too small, the shape retention of the solid electrolyte sheet may deteriorate. Also, when the thickness ratio of the porous substrate to the solid electrolyte sheet is large to a certain extent, in addition to smoothing the movement of lithium ions on the positive electrode side and smoothing the movement of lithium ions on the negative electrode side, the effect of suppressing metal deposition that causes charging abnormalities is more noticeable. Therefore, for these reasons, the thickness of the porous substrate is preferably 30% or more of the thickness of the solid electrolyte sheet, and it is more preferably 50% or more thereof.

A specific thickness of the porous substrate is, for example, preferably 3 μm or more, more preferably 8 μm or more, and preferably 45 μm or less, and more preferably 25 μm or less.

The percentage of the porous substrate to the solid electrolyte sheet (the percentage of actual volume excluding the pores) is preferably 30% by volume or less, and more preferably 25% by volume or less, from the viewpoint of ensuring favorable lithium-ion conductivity. Note that, when the percentage of the porous substrate to the solid electrolyte sheet is too small, the effect of improving the shape retention of the solid electrolyte sheet may deteriorate. Therefore, from the viewpoint of further increasing the strength of the solid electrolyte sheet, the percentage of the porous substrate to the solid electrolyte sheet is preferably 5% by volume or more, and more preferably 10% by volume or more.

Also, from the viewpoint of further improving the shape retention of the solid electrolyte sheet, the content of the binder in the solid electrolyte sheet is preferably 0.5% by mass or more and more preferably 1% by mass or more with respect to the total amount of the solid electrolyte and the binder. Also, from the viewpoint of limiting the amount of binder to some extent and suppressing deterioration in lithium-ion conductivity, the content of the binder in the solid electrolyte sheet is preferably 5% by mass or less, and more preferably 3% by mass or less.

Although there is no particular limitation on a method for producing a solid electrolyte sheet, it is preferable to produce a solid electrolyte sheet using a method including a process of preparing a slurry for forming the solid electrolyte layer and the like by dispersing the solid electrolyte and a binder used as needed in a solvent, and successively filling, in a wet process, pores of the porous substrate with these slurries (filling process). When a surface portion of the solid electrolyte sheet is constituted only by the solid electrolyte (and the binder or the like) in which no porous substrate is present, the pores of the porous substrate may be filled with the slurries in the filling process, and coating films of these slurries may be formed on the surface of the porous substrate. Such a method improves the strength of the solid electrolyte sheet, and it facilitates the production of a solid electrolyte sheet having a large area.

A coating method such as a screen printing method, a doctor blade method, or an immersion method can be adopted as a method for filling the pores of the porous substrate with a slurry containing a solid electrolyte and further forming the slurry coating film on the surface of the porous substrate.

The slurry is prepared by introducing the solid electrolyte, and a binder as needed, into a solvent, and mixing the resulting mixture. It is preferable to select a slurry solvent that is less likely to deteriorate a solid electrolyte. In particular, the sulfide-based solid electrolytes and the hydride-based solid electrolytes cause chemical reactions with a minute amount of water, and therefore, it is preferable to use non-polar aprotic solvents such as hydrocarbon solvents including hexane, heptane, octane, nonane, decane, decaline, toluene, and xylene. In particular, it is more preferable to use a super dehydrated solvent in which the water content is reduced to 0.001% by mass (10 ppm) or less. It is also possible to use fluorine-based solvents such as “Vertrel (registered trademark)” manufactured by Du Pont-Mitsui Fluorochemicals Co., Ltd., “Zeorora (registered trademark)” manufactured by Zeon Corporation, and “Novec (registered trademark)” manufactured by Sumitomo 3M Limited, and nonaqueous organic solvents such as dichloromethane and diethyl ether.

After the pores of the porous substrate are filled with the slurry and the slurry coating film is formed on the surface of the porous substrate as described above, the solvent of the slurry is removed by drying, and compression molding is performed as necessary, whereby the solid electrolyte sheet can be obtained.

Note that, as described above, the method for producing the solid electrolyte sheet is not limited to the above wet process. For example, when pores of the porous substrate are filled with a solid electrolyte (and a binder used as needed), the pores may be filled with the solid electrolyte or a mixture of the solid electrolyte and a binder in a dry process, and compression molding may be performed. Also, in a case where the surface of the porous substrate is covered with the solid electrolyte, a sheet obtained by molding a mixture of the solid electrolyte and the binder may be attached to the surface of a sheet obtained by filling pores of the porous substrate with the solid electrolyte.

The outer periphery of the solid electrolyte layer (I) prepared using the solid electrolyte sheet preferably protrudes from the positive electrode [the molded body of the positive electrode mixture (the positive electrode mixture layer)] and the negative electrode [the molded body of the negative electrode mixture (the negative electrode mixture layer)] in a plan view, and the width of the protruding portion [the length of the shortest distance from the end portion of each of the molded body of the positive electrode mixture (the positive electrode mixture layer) and the molded body of the negative electrode mixture (the negative electrode mixture layer) to the end portion of the solid electrolyte layer (I)] can be, for example, 1 μm to 1 mm.

### [Solid Electrolyte Layer (II) and Solid Electrolyte Layer (III)]

The solid electrolyte layer (II) and the solid electrolyte layer (III) each contain a solid electrolyte, and specific examples of the solid electrolyte include the same sulfide-based solid electrolyte, hydride-based solid electrolyte, halide-based solid electrolyte, and oxide-based solid electrolyte as those exemplified above as those constituting the solid electrolyte layer (I).

As the solid electrolyte of each of the solid electrolyte layer (II) and the solid electrolyte layer (III), the solid electrolytes listed above may be used alone or in combination of two or more. Among these solid electrolytes, sulfide-based solid electrolytes are preferable because sulfide-based solid electrolytes have high lithium-ion conductivity, sulfide-based solid electrolytes containing Li and P are more preferable, and in particular, sulfide-based solid electrolytes having an argyrodite-type structure and having high lithium-ion conductivity and high chemical stability are even more preferable.

In addition, the solid electrolyte contained in the solid electrolyte layer (I), the solid electrolyte contained in the solid electrolyte layer (II), and the solid electrolyte contained in the solid electrolyte layer (III) may be the same kind in all the layers, may be the same kind in two layers of the three layers and a different kind in the remaining one layer, or may be different kinds in the respective layers. For example, the solid electrolyte contained in at least one of the solid electrolyte layer (II) and the solid electrolyte layer (III) may be different from the solid electrolyte contained in the solid electrolyte layer (I).

The solid electrolyte layer (II) and the solid electrolyte layer (III) each can contain a binder. As the binder contained in each of the solid electrolyte layer (II) and the solid electrolyte layer (III), the same binder as the binder exemplified above as the binder that can be contained in the solid electrolyte layer (I) can be used.

In a case where the solid electrolyte layer (II) and the solid electrolyte layer (III) each contain a binder, the content ratio thereof is preferably 2 to 10% by mass (the remainder can be the solid electrolyte). In a case where good moldability can be secured without containing a binder in the solid electrolyte layer (II) and the solid electrolyte layer (III), the solid electrolyte layer (II) and the solid electrolyte layer (III) may be formed only of, for example, the solid electrolyte without containing a binder in the solid electrolyte layer (II) and the solid electrolyte layer (III) (the content ratio of the binder may be 0% by mass). Note that it is also possible to employ a configuration in which only one of the solid electrolyte layer (II) and the solid electrolyte layer (III) contains no binder, and the other thereof contains a binder.

The thickness of each of the solid electrolyte layer (II) and the solid electrolyte layer (III) is preferably 1 to 10 μm from the viewpoint of improving the lithium-ion conductivity. The thickness of the solid electrolyte layer (II) and the thickness of the solid electrolyte layer (III) may be the same as or different from each other.

The area of each of the solid electrolyte layer (II) and the solid electrolyte layer (III) in a plan view can be smaller than the area of the solid electrolyte layer (I) in a plan view, and can be, for example, the same as the area of the molded body of the positive electrode mixture (positive electrode mixture layer) and the area of the molded body of the negative electrode mixture (negative electrode mixture layer).

The solid electrolyte layer (II) and the solid electrolyte layer (III) can be formed by disposing the solid electrolyte and the like in a stacked manner on the surface of the solid electrolyte sheet, and compression-molding the resultant in a state of being overlapped with the molded body of the positive electrode mixture (positive electrode mixture layer) or the molded body of the negative electrode mixture (negative electrode mixture layer), but it is preferable to form the solid electrolyte layer (II) and the solid electrolyte layer (III) by disposing the solid electrolyte and the like in a stacked manner on one surface of the molded body of the positive electrode mixture (positive electrode mixture layer) or the molded body of the negative electrode mixture (negative electrode mixture layer) formed in advance as a substrate, covering one surface with the solid electrolyte, and then compression-molding the resultant in a state of being overlapped with the solid electrolyte sheet.

### (Total Thickness of Solid Electrolyte Layer)

The total thickness of the solid electrolyte layer [the total thickness of the solid electrolyte layer (I), the solid electrolyte layer (II), and the solid electrolyte layer (III)] is preferably 5 μm or more, and more preferably 20 μm or more, and is preferably 100 μm or less, and more preferably 50 μm or less, from the viewpoint of optimizing the distance between the positive electrode and the negative electrode of the battery and suppressing the occurrence of short-circuiting and an increase in resistance.

### <Positive Electrode>

Examples of the positive electrode of the all-solid-state battery include a positive electrode having a structure in which a layer (a positive electrode mixture layer) constituted by a molded body made of the positive electrode mixture containing the positive electrode active material and the solid electrolyte is formed on a current collector, a positive electrode constituted only by a molded body made of the positive electrode mixture (pellet or the like), a positive electrode in which pores of a conductive porous substrate are filled with a positive electrode mixture containing a positive electrode active material and a solid electrolyte, and the like.

As a positive electrode active material in a case where the all-solid-state battery is a primary battery, it is possible to use the same positive electrode active material that is used in conventionally known nonaqueous electrolyte primary batteries or the like. Specifically, examples thereof include manganese dioxide, lithium-containing manganese oxides [e.g., LiMn₃O₆, composite oxides, which have the same crystal structure (β-type structure, γ-type structure, or a structure in which β-type and γ-type are mixed) as manganese dioxide, and in which the Li content is 3.5% by mass or less, preferably 2% by mass or less, more preferably 1.5% by mass or less, and particularly preferably 1% by mass or less, or the like], lithium-containing composite oxides such as LiₐTi_{5/3}O₄ (4/3≤a<7/3); vanadium oxide; niobium oxide; titanium oxide; sulfides such as iron disulfide; graphite fluoride; silver sulfides such as Ag₂S; and nickel oxides such as NiO₂.

Also, it is possible to use the same positive electrode active material that is used in conventionally known nonaqueous electrolyte secondary batteries or the like in a case where the all-solid-state battery is a positive electrode of a secondary battery. Specific examples of the positive electrode active material include one or two or more types of particles of various positive electrode active materials used in conventionally known nonaqueous electrolyte secondary batteries, such as spinel-type lithium manganese composite oxides represented by LiMᵣMn₂₋ᵣO₄ (where M is at least one element selected from the group consisting of Li, Na, K, B, Mg, Ca, Sr, Ba, Ti, V, Cr, Zr, Fe, Co, Ni, Cu, Zn, Al, Sn, Sb, In, Nb, Ta, Mo, W, Y, Ru, and Rh, and r satisfies 0≤r≤1), layered compounds represented by LiᵣMn₍₁₋ₛ₋ᵣ₎NiₛMₜO₍₂₋ᵤ₎Fᵥ (where M is at least one element selected from the group consisting of Co, Mg, Al, B, Ti, V, Cr, Fe, Cu, Zn, Zr, Mo, Sn, Ca, Sr, and W, and r, s, t, u, and v satisfy 0.8≤r≤1.2, 0<s<0.5, 0≤t≤0.5, u+v<1, −0.1≤u≤0.2, and 0≤v≤0.1), lithium cobalt composite oxides represented by LiCo₁₋ᵣMᵣO₂ (where M is at least one element selected from the group consisting of Al, Mg, Ti, V, Cr, Zr, Fe, Ni, Cu, Zn, Ga, Ge, Nb, Mo, Sn, Sb, and Ba, and r satisfies 0≤r≤0.5), lithium nickel composite oxides represented by LiNi₁₋ᵣMᵣO₂ (where M is at least one element selected from the group consisting of Al, Mg, Ti, Zr, Fe, Co, Cu, Zn, Ga, Ge, Nb, Mo, Sn, Sb, and Ba, and r satisfies 0≤r≤0.5), olivine-type composite oxides represented by Li₁₊ₛM₁₋ᵣNᵣPO₄Fₛ (where M is at least one element selected from the group consisting of Fe, Mn, and Co, N is at least one element selected from the group consisting of Al, Mg, Ti, Zr, Ni, Cu, Zn, Ga, Ge, Nb, Mo, Sn, Sb, V, and Ba, and r and s satisfy 0≤r≤0.5, 0≤s≤1), and pyrophosphate compounds represented by Li₂M₁₋ᵣNᵣP₂O₇ (where M is at least one element selected from the group consisting of Fe, Mn, and Co, N is at least one element selected from the group consisting of Al, Mg, Ti, Zr, Ni, Cu, Zn, Ga, Ge, Nb, Mo, Sn, Sb, V, and Ba, and r satisfies 0≤r≤0.5).

In a case where the all-solid-state battery is a secondary battery, the average particle size of the positive electrode active material is preferably 1 μm or more, more preferably 2 μm or more, and preferably 10 μm or less, and more preferably 8 μm or less. Note that the positive electrode active material may be primary particles or secondary particles obtained through aggregation of primary particles. When a positive electrode active material having an average particle diameter in the above range is used, a large interface with the solid electrolyte contained in the positive electrode can be obtained, thus enhancing output characteristics of the battery.

In a case where the all-solid-state battery is a secondary battery, it is preferable that the positive electrode active material includes, on its surface, a reaction suppressing layer for suppressing a reaction between the positive electrode active material and the solid electrolyte contained in the positive electrode.

If the positive electrode active material comes into direct contact with the solid electrolyte in the positive electrode, there is a risk that the solid electrolyte will be oxidized and a resistive layer will be formed, which will lead to a reduction in ion conductivity in the positive electrode. It is possible to suppress a reduction in ion conductivity in the positive electrode due to oxidation of the solid electrolyte by providing the reaction suppressing layer for suppressing a reaction with the solid electrolyte on the surface of the positive electrode active material to prevent direct contact between the positive electrode active material and the solid electrolyte.

The reaction suppressing layer is only required to be made of a material that has ion conductivity and can suppress a reaction between the solid electrolyte and particles of the electrode active material (the positive electrode active material). Examples of materials that can form the reaction suppressing layer include oxides that include Li and at least one element selected from the group consisting of Nb, P, B, Si, Ge, Ti, Zr, Ta, and W or more specifically, Nb-containing oxides such as LiNbO₃, and LiPO₄, Li₃BO₃, Li₂SO₄, Li₄SiO₄, Li₄GeO₄, LiTiO₃, LiZrO₃, and Li₂WO₄. The reaction suppressing layer may contain only one of these oxides, two or more of these oxides, or a composite compound formed by two or more of these oxides. Among these oxides, Nb-containing oxides are preferably used, and LiNbO₃ is more preferably used.

Preferably, 0.1 to 1.0 part by mass of the reaction suppressing layer is present on the surface of the positive electrode active material relative to 100 parts by mass of the positive electrode active material. When the amount of the reaction suppressing layer is within this range, it is possible to favorably suppress a reaction between the positive electrode active material and the solid electrolyte.

The reaction suppressing layer can be formed on the surface of the positive electrode active material using a sol-gel method, a mechano-fusion method, a CVD method, a PVD method, an ALD method, or the like.

The content of the positive electrode active material in the positive electrode mixture is preferably 60% by mass to 85% by mass from the viewpoint of further increasing the energy density of the all-solid-state battery.

It is possible to add a conductive assistant to the positive electrode mixture. Specific examples thereof include carbon materials such as graphite (natural graphite, artificial graphite), graphene, carbon black, carbon nanofiber, and carbon nanotubes. Note that, for example, in a case where Ag₂S is used as an active material, conductive Ag is generated during the discharge reaction, and thus a conductive assistant does not need to be added. When a conductive assistant is added to the positive electrode mixture, the content of the conductive assistant is preferably 1.0 part by mass or more, and is preferably 7.0 parts by mass or less, and more preferably 6.5 parts by mass or less, where the content of the positive electrode active material is 100 parts by mass.

It is possible to add a binder to the positive electrode mixture. Specific examples thereof include fluororesins such as polyvinylidene fluoride (PVDF). Note that, for example, in a case where favorable moldability can be ensured when a positive electrode is formed without using a binder as in the case where a sulfide-based solid electrolyte is added to the positive electrode mixture (details will be described later), a binder does not need to be added to the positive electrode mixture.

In a case where the positive electrode mixture requires a binder, the binder content is preferably 15% by mass or less, and preferably 0.5% by mass or more. On the other hand, when moldability of the positive electrode mixture can be obtained without the need for a binder, the binder content is preferably 0.5% by mass or less, more preferably 0.3% by mass or less, and even more preferably 0% by mass (i.e., no binder is added).

It is possible to add a solid electrolyte to the positive electrode mixture.

There is no particular limitation on the solid electrolyte added to the positive electrode mixture as long as the solid electrolyte has lithium-ion conductivity, and for example, the sulfide-based solid electrolyte, the hydride-based solid electrolyte, the halide-based solid electrolyte, the oxide-based solid electrolyte, and the like exemplified above as those that can be used in the solid electrolyte layer of the solid electrolyte sheet can be used.

The average particle size of the solid electrolyte is preferably 0.1 μm or more, and more preferably 0.2 μm or more, from the viewpoint of reducing grain boundary resistance, and preferably 10 μm or less, and more preferably 5 μm or less, from the viewpoint of forming a sufficient contact interface between the active material and the solid electrolyte.

From the viewpoint of further increasing the ionic conductivity in the positive electrode and further improving output characteristics of the all-solid-state battery, the content of the solid electrolyte in the positive electrode mixture is preferably 10 parts by mass or more, and more preferably 15 parts by mass or more, when the content of the positive electrode active material is set to 100 parts by mass. However, if the amount of the solid electrolyte in the positive electrode mixture is too large, the amounts of other components will be reduced, which may reduce effects of these components. Therefore, the content of the solid electrolyte in the positive electrode mixture is preferably 65 parts by mass or less, and more preferably 60 parts by mass or less, when the content of the positive electrode active material is 100 parts by mass.

In a case where a current collector is used in the positive electrode, as a current collector, a foil made of a metal such as aluminum, stainless steel, or the like; a sheet-like conductive porous substrate, such as a punched metal, a mesh, an expanded metal, or a foamed metal; a carbon sheet; or the like can be used. As a sheet-like conductive porous substrate, it is preferable to use a foamed metal porous body. A specific example of a foamed metal porous body is “Celmet (registered trademark)” available from Sumitomo Electric Industries, Ltd.

The positive electrode can be produced using a method for applying a positive electrode mixture-containing composition (paste, slurry, or the like) obtained by dispersing, in a solvent, the positive electrode active material and the solid electrolyte, and a conductive assistant, a binder, and the like that are to be added as needed, to the current collector, drying the composition, and then performing compression molding such as calendering as necessary, to form a molded body (positive electrode mixture layer) made of the positive electrode mixture on the surface of the current collector.

Water or an organic solvent such as N-methyl-2-pyrrolidone (NMP) can be used as the solvent in the positive electrode mixture-containing composition. However, when a solid electrolyte that is highly reactive to water is used, it is desirable to select a solvent that is less likely to deteriorate the solid electrolyte, and it is preferable to use any of the above-listed various examples of solvents for the slurry for forming a solid electrolyte sheet.

Also, in addition to the above method, a molded body made of a positive electrode mixture may be formed by compressing, using compression molding or the like, the positive electrode mixture prepared by mixing the positive electrode active material, and a solid electrolyte with a conductive assistant, a binder, and the like that are added as needed, for example. The molded body made of the positive electrode mixture obtained using such a method can also be used directly as a positive electrode as described above, or a molded body to which a current collector is press-bonded or the like can also be used as a positive electrode.

The molded body made of a positive electrode mixture (a positive electrode mixture layer) formed using a positive electrode mixture-containing composition that contains a solvent preferably has a thickness (when a current collector is provided, the thickness per side of the current collector) of 10 to 1000 μm. Further, the molded body made of a positive electrode mixture obtained through compression molding preferably has a thickness of 0.15 to 4 mm.

The current collector at the positive electrode preferably has a thickness of 0.01 to 0.1 mm.

In addition, when a conductive porous substrate is used for a positive electrode current collector, for example, the positive electrode can be produced by, for example, filling pores of the conductive porous substrate with the positive electrode mixture-containing composition, drying the substrate, and then performing compression molding such as calendering as needed.

Furthermore, a positive electrode may be produced using a method for filling, in a dry process, pores of a conductive porous substrate with a positive electrode mixture that does not contain a solvent and contains a positive electrode active material, a solid electrolyte, a conductive assistant, a binder, and the like instead of the positive electrode mixture-containing composition, and performing compression molding such as calendering as needed.

A positive electrode obtained using a method for filling pores of a conductive porous substrate with a positive electrode mixture-containing composition or a positive electrode mixture preferably has a thickness of 30 to 4000 μm.

### <Negative Electrode>

A negative electrode of the all-solid-state battery includes, for example, a molded body made of a negative electrode mixture containing a negative electrode active material, a lithium sheet, or a lithium alloy sheet. Further, pores of a conductive porous substrate may be filled with a negative electrode mixture containing a negative electrode active material, and the resultant may be used as a negative electrode.

In a case where the negative electrode is a molded body made of a negative electrode mixture containing a negative electrode active material, examples thereof include a negative electrode having a structure in which a layer (a negative electrode mixture layer) constituted by the molded body made of the negative electrode mixture is formed on a current collector, a negative electrode constituted only by a molded body made of the negative electrode mixture (pellets or the like), and the like.

Examples of the negative electrode active material include carbon materials such as graphite, lithium titanium oxides (such as lithium titanate), simple substances and compounds (such as oxides) that contain elements such as Si or Sn, and alloys thereof. It is also possible to use, as negative electrode active materials, lithium metal and lithium alloys (lithium-aluminum alloy, lithium-indium alloy, and the like).

The content of the negative electrode active material in the negative electrode mixture is preferably 40% by mass to 80% by mass from the viewpoint of further increasing the energy density of the battery.

It is possible to add a conductive assistant to the negative electrode mixture. Specific examples thereof include conductive assistants that are the same as those listed above to be added to the positive electrode mixture. The content of the conductive assistant in the negative electrode mixture is preferably 10 to 30 parts by mass when the content of the negative electrode active material is 100 parts by mass.

Also, it is possible to add a binder to the negative electrode mixture. Specific examples thereof include binders that are the same as those listed above to be added to the positive electrode mixture. Note that, for example, in a case where favorable moldability can be ensured when a negative electrode mixture layer is formed without using a binder as in the case where a sulfide-based solid electrolyte is added to the negative electrode mixture (will be described later), a binder does not need to be added to the negative electrode mixture.

In a case where the negative electrode mixture requires a binder, the binder content is preferably 15% by mass or less, and preferably 0.5% by mass or more. On the other hand, in a case where moldability of the negative electrode mixture can be obtained without the need for a binder, the binder content is preferably 0.5% by mass or less, more preferably 0.3% by mass or less, and even more preferably 0% by mass (i.e., no binder is added).

It is possible to add a solid electrolyte to the negative electrode mixture. Specific examples thereof include solid electrolytes that are the same as those listed above to be added to the positive electrode mixture. Among the solid electrolytes listed above as examples, it is preferable to use sulfide-based solid electrolytes because they have high lithium-ion conductivity and also function to improve the moldability of the negative electrode mixture, and it is more preferable to use sulfide-based solid electrolytes having an argyrodite-type structure.

For the same reasons as in the case of the positive electrode mixture, the average particle size of the solid electrolyte in the negative electrode mixture is preferably 0.1 μm or more, and more preferably 0.2 μm or more, and preferably 10 man or less, and more preferably 5 μm or less.

From the viewpoint of further increasing the ionic conductivity in the negative electrode and further improving output characteristics of the all-solid-state battery, the content of the solid electrolyte in the negative electrode mixture is preferably 30 parts by mass or more, and more preferably 35 parts by mass or more, when the content of the negative electrode active material is set to 100 parts by mass. However, if the amount of the solid electrolyte in the negative electrode mixture is too large, the amounts of other components will be reduced, which may reduce effects of these components. Therefore, the content of the solid electrolyte in the negative electrode mixture is preferably 130 parts by mass or less, and more preferably 110 parts by mass, when the content of the negative electrode active material is set to 100 parts by mass or less.

When a current collector is used in the negative electrode having a molded body made of a negative electrode mixture, as a current collector, a foil made of copper or nickel, a sheet-like conductive porous substrate, such as a punched metal, a mesh, an expanded metal, or a foamed metal, or the like; a carbon sheet; or the like can be used. As a sheet-like conductive porous substrate, it is preferable to use a foamed metal porous body. A specific example of the foamed metal porous body is “Celmet (registered trademark)” available from Sumitomo Electric Industries, Ltd.

The negative electrode can be produced using a method for applying a negative electrode mixture-containing composition (paste, slurry, or the like) obtained by dispersing, in a solvent, the negative electrode active material, and a conductive assistant, a solid electrolyte, a binder, and the like that are to be added as needed, to the current collector, drying the composition, and then performing compression molding such as calendering as necessary, to form a molded body (negative electrode mixture layer) made of the negative electrode mixture on the surface of the current collector.

Water or an organic solvent such as NMP can be used as the solvent in the negative electrode mixture-containing composition. However, when a solid electrolyte is also added to the negative electrode mixture-containing composition, it is desirable to select a solvent that is less likely to deteriorate the solid electrolyte, and it is preferable to use any of the above-listed various examples of solvents for the slurry for forming a solid electrolyte sheet.

Also, in addition to the above method, a molded body made of a negative electrode mixture may be formed by compressing, using compression molding or the like, the negative electrode mixture prepared by mixing the negative electrode active material, and a conductive assistant, a solid electrolyte, and a binder and the like that are added as needed. As described above, the molded body made of the negative electrode mixture obtained using such a method can also be used directly as a negative electrode, or a molded body to which a current collector is press-bonded or the like can also be used as a negative electrode.

The molded body made of a negative electrode mixture (a negative electrode mixture layer) formed using a negative electrode mixture-containing composition that contains a solvent preferably has a thickness (when a current collector is provided, the thickness per side of the current collector) of 10 to 1000 μm. Further, the molded body made of a negative electrode mixture obtained through compression molding preferably has a thickness of 0.15 to 4 mm.

The current collector at the negative electrode preferably has a thickness of 0.01 to 0.1 mm.

Also, in a case where a conductive porous substrate such as a punched metal is used for a negative electrode current collector, for example, the negative electrode can be produced by filling pores of the conductive porous substrate with the negative electrode mixture-containing composition, drying the substrate, and then performing compression molding such as calendering as needed. The negative electrode produced using such a method readily has high strength, thus making it possible to hold a solid electrolyte sheet with a larger area.

Furthermore, a negative electrode may be produced using a method for filling, in a diy process, pores of a conductive porous substrate with a negative electrode mixture that does not contain a solvent and contains a negative electrode active material, a solid electrolyte, a binder, a conductive assistant, and the like instead of the negative electrode mixture-containing composition, and performing compression molding such as calendering as needed.

A negative electrode obtained using a method for filling pores of a conductive porous substrate with a negative electrode mixture-containing composition or a negative electrode mixture preferably has a thickness of 30 to 4000 μm.

In a case where a negative electrode has a lithium sheet or a lithium alloy sheet, sheets constituted only by lithium sheets or lithium alloy sheets, or sheets obtained by bonding these sheets to current collectors are used.

Examples of alloying elements for lithium alloys include aluminum, lead, bismuth, indium, and gallium, and aluminum and indium are preferable. The percentage of alloying elements in a lithium alloy (in a case where the lithium alloy contains a plurality of types of alloying elements, the percentage of these alloying elements) is preferably 50 atomic % or less (in this case, the remaining portion is lithium and inevitable impurities).

Also, in a case where a negative electrode has a sheet made of a lithium alloy, a stack is prepared by stacking a layer that contains an alloying element for forming a lithium alloy on the surface of a lithium layer (a layer containing lithium) constituted by a lithium metal foil or the like through press-bonding, for example, and the negative electrode can be prepared by forming a lithium alloy on the surface of the lithium layer by bringing the stack into contact with a solid electrolyte in a battery. In the case of such a negative electrode, a stack having a layer containing an alloying element on only one surface of the lithium layer may be used, or a stack having a layer containing an alloying element on both surfaces of the lithium layer may also be used. The stack can be formed, for example, by press-bonding a lithium metal foil and a foil made of an alloying element to each other.

Further, a current collector can also be used when a lithium alloy is formed in a battery to form a negative electrode. For example, a stack having a lithium layer on one surface of a negative electrode current collector and a layer containing an alloying element on a surface of the lithium layer opposite to the negative electrode current collector may be used, or a stack having lithium layers on both surfaces of the negative electrode current collector and a layer containing an alloying element on a surface of each lithium layer opposite to the negative electrode current collector may be used. The negative electrode current collector and the lithium layer (lithium metal foil) may be stacked on each other through press-bonding or the like.

It is possible to use, for example, a foil made of these alloying elements or the like, for the layer containing the alloying element according to the stack used as a negative electrode. The thickness of the layer containing the alloying element is preferably 1 μm or more, more preferably 3 μm or more, preferably 20 μm or less, and more preferably 12 μm or less.

It is possible to use, for example, a lithium metal foil or the like for the lithium layer according to the stack used as a negative electrode. The lithium layer preferably has a thickness of 0.1 to 1.5 mm. Further, the sheet according to the negative electrode having a lithium sheet or a lithium alloy sheet also preferably has a thickness of 0.1 to 1.5 mm.

In a case where the negative electrode having a lithium sheet or a lithium alloy sheet has a current collector, it is possible to use, for the current collector, the same current collector as those listed above that can be used for a negative electrode having a molded body made of a negative electrode mixture.

### <Electrode Body>

The positive electrode and the negative electrode can be used for a battery in the form of a stacked electrode body obtained by stacking the electrodes with the solid electrolyte layer being located therebetween or in the form of a rolled-up electrode body obtained by rolling up the above-mentioned stacked electrode body.

In a case of forming the electrode body, a method can be adopted in which a positive electrode in which a covering layer of a solid electrolyte is formed on the surface of a molded body of a positive electrode mixture (positive electrode mixture layer) and a negative electrode in which a covering layer of a solid electrolyte is formed on the surface of a molded body of a negative electrode mixture (negative electrode mixture layer) are used in advance, and these are stacked and compression-molded with a solid electrolyte sheet for forming the solid electrolyte layer (I) in such a manner that the covering layer of the solid electrolyte formed on each of the surfaces of the molded body of the positive electrode mixture and the molded body of the negative electrode mixture is on the solid electrolyte sheet side. This can suppress the peeling between the solid electrolyte layer and each of the positive electrode and the negative electrode and the occurrence of a short circuit due to cracking of the solid electrolyte layer during the formation of the electrode body or after the battery is formed, which can increase the reliability and productivity of the battery. The covering layer has a thickness of, for example, 5 to 30 μm.

### <Form of Battery>

The form of all-solid-state batteries is not limited to one having an exterior body constituted by an exterior can, a sealing can, and a gasket as shown in FIG. 1, that is, one with a form generally referred to as a coin-shaped battery or a button-shaped battery. For example, the all-solid-state battery may have an exterior body constituted by a resin film or metal-resin laminate film, may have an exterior body including a metal tubular (cylindrical or rectangular cylindrical) exterior can having a bottom and a sealing structure that seals the opening of the can, or may have a ceramic box-shaped exterior body.

### EXAMPLES

Hereinafter, the present invention will be described in detail based on examples. However, the examples below do not limit the present invention.

### Example 1

Using xylene (“super dehydrated” grade) having a water content of 0.001% by mass (10 ppm) or less, a sulfide-based solid electrolyte (Li₆PS₅Cl) having an average particle size of 1.0 μm, an acryl resin binder, and a dispersant were mixed at a mass ratio of 100:3:1 in such a manner that the solid content ratio was 40%, and the mixture was stirred for 10 minutes with a Thinky mixer to prepare a uniform slurry.

A PET nonwoven fabric having a thickness of 40 μm and a basis weight of 8 g/m² was used as a porous substrate, and the nonwoven fabric was pulled up through the slurry and then vacuum-dried at 120° C. for 1 hour to prepare a solid electrolyte sheet having a thickness of 42 μm.

The solid electrolyte sheet was punched into a circular shape and the resultant was used for assembling an all-solid-state battery.

Lithium titanate having an average particle size of 2 μm (Li₄Ti₅O₁₂, negative electrode active material), a sulfide-based solid electrolyte having an average particle size of 0.7 μm (Li₆PS₅Cl), and graphene (conductive assistant) were mixed at a mass ratio of 50:41:9 to prepare a negative electrode mixture.

Next, the negative electrode mixture was placed in a powder molding die and was subjected to compression molding using a press machine, thereby preparing a molded body of a negative electrode. Further, a sulfide-based solid electrolyte (Li₆PS₅Cl) having an average particle size of 0.7 μm was disposed on the upper surface of the molded body of the negative electrode, and was subjected to compression molding at a surface pressure of 70 MPa using a press machine, thereby forming a temporarily molded layer (covering layer) of the solid electrolyte having a thickness of 10 μm.

In addition, LiCoO₂ (positive electrode active material) having an average particle size of 5 μm and having a covering layer of LiNbO₃ formed on the surface thereof, a sulfide-based solid electrolyte (Li₆PS₅Cl) having an average particle size of 0.7 μm, and graphene were mixed at a mass ratio of 65:30.7:4.3 to prepare a positive electrode mixture.

Next, the positive electrode mixture was placed in a powder molding die and was subjected to compression molding using a press machine, thereby preparing a molded body of a positive electrode. Further, a sulfide-based solid electrolyte (Li₆PS₅Cl) having an average particle size of 0.7 μm was disposed on the upper surface of the molded body of the positive electrode, and was subjected to compression molding at a surface pressure of 70 MPa using a press machine, thereby forming a temporarily molded layer (covering layer) of the solid electrolyte having a thickness of 10 μm.

Next, the negative electrode and the positive electrode were stacked on the solid electrolyte sheet in such a manner that the temporarily molded layer of the solid electrolyte was on the solid electrolyte sheet side, and the whole was pressurized and integrated to obtain an electrode body in which the positive electrode and the negative electrode were stacked with the solid electrolyte layer interposed therebetween. The solid electrolyte layer (II) bonded to the positive electrode had the same size as the positive electrode in a plan view, the solid electrolyte layer (III) bonded to the negative electrode had the same size as the negative electrode in a plan view, and the solid electrolyte sheet [solid electrolyte layer (I)] had a size protruding from the circumference of the positive electrode and the negative electrode by a width of 2 mm. The total thickness of the solid electrolyte layers was 31 μm, and the thicknesses of the solid electrolyte layers (I), (II), and (III) were 25 μm, 3 μm, and 3 μm, respectively.

The electrode body was sealed in a battery container composed of an exterior can and a sealing can to prepare an all-solid-state battery. Note that a graphite sheet was interposed between the electrode body and the exterior can and between the electrode body and the sealing can.

### Comparative Example 1

An electrode body was prepared in the same manner as in Example 1 except that the temporarily molded layer (covering layer) of the solid electrolyte was not formed on the positive electrode and the negative electrode, and the molded body of the negative electrode and the molded body of the positive electrode were brought into direct contact with the solid electrolyte sheet.

An all-solid-state battery was prepared in the same manner as in Example 1 using the electrode body.

After the batteries of Example 1 and Comparative Example 1 were charged and discharged, the AC impedance at 1 kHz was measured at an applied voltage of 10 mV. The results are shown in Table 1.

TABLE 1

| | Impedance |
|---|---|
| | (Ω) |
| Example 1 | 16 |
| Comparative Example 1 | 30 |

As shown in Table 1, in Example 1, the bonding between the positive electrode and the solid electrolyte layer and the bonding between the negative electrode and the solid electrolyte layer in the electrode body were good, which decreased the internal resistance of the battery, but in Comparative Example 1, the bonding between the positive electrode and the solid electrolyte layer and the bonding between the negative electrode and the solid electrolyte layer in the electrode body were insufficient, which increased the internal resistance of the battery.

The invention may be embodied in other forms without departing from the essential characteristics thereof. The embodiments disclosed in this application are to be considered in all respects as illustrative and not limiting. The scope of the present invention should be construed in view of the appended claims, rather than the foregoing description, and all changes that come within the meaning and range of equivalency of the claims are intended to be embraced therein.

### INDUSTRIAL APPLICABILITY

An all-solid-state battery according to the present invention can be applied to the same applications as conventionally known primary batteries and secondary batteries, but the all-solid-state battery has great heat resistance because it has a solid electrolyte instead of an organic electrolyte solution. Therefore, the all-solid-state battery according to the present invention can be preferably used in applications in which the battery is exposed to high temperatures.

### DESCRIPTION OF REFERENCE NUMERALS

10 All-solid-state battery
20 Positive electrode
30 Negative electrode
40 Solid electrolyte layer
41 Solid electrolyte layer (I)
42 Solid electrolyte layer (II)
43 Solid electrolyte layer (III)
50 Exterior can
60 Sealing can
70 Gasket

1. An all-solid-state battery comprising an electrode body formed by stacking a positive electrode and a negative electrode with a solid electrolyte layer interposed therebetween, wherein
the solid electrolyte layer is a stack including:
a solid electrolyte layer (I) including a porous substrate and having a portion protruding from an end portion of the positive electrode and the negative electrode in a plan view;
a solid electrolyte layer (II) bonded to the positive electrode and having a smaller area than an area of the solid electrolyte layer (I) in a plan view; and
a solid electrolyte layer (III) bonded to the negative electrode and having a smaller area than the area of the solid electrolyte layer (I) in a plan view,
at least one of a solid electrolyte of the solid electrolyte layer (II) or a solid electrolyte of the solid electrolyte layer (III) is different from a solid electrolyte of the solid electrolyte layer (I), and
an outer periphery of an end portion of the solid electrolyte layer (I) protrudes from an end portion of the positive electrode or the negative electrode by 1 μm to 1 mm in a plan view.

2. The all-solid-state battery according to claim 1, wherein a total thickness of the solid electrolyte layer is 5 to 100 μm.

3. The all-solid-state battery according to claim 1, wherein the solid electrolyte layer (II) is formed to have the same size as a size of the positive electrode.

4. The all-solid-state battery according to claim 1, wherein the solid electrolyte layer (III) is formed to have the same size as a size of the negative electrode.

5. The all-solid-state battery according to claim 1, wherein the portion of the solid electrolyte layer (I) protruding from the end portion of the positive electrode and the negative electrode is formed in a ring shape.

6. The all-solid-state battery according to claim 1, wherein at least one of the solid electrolyte of the solid electrolyte layer (II) and the solid electrolyte of the solid electrolyte layer (III) contains no binder.

7. A method for producing an all-solid-state battery including an electrode body formed by stacking a positive electrode and a negative electrode with a solid electrolyte layer interposed therebetween,
the solid electrolyte layer being a stack of a solid electrolyte layer (I) having a porous substrate, a solid electrolyte layer (II) bonded to the positive electrode, and a solid electrolyte layer (III) bonded to the negative electrode, at least one of a solid electrolyte of the solid electrolyte layer (II) and a solid electrolyte of the solid electrolyte layer (III) being different from a solid electrolyte of the solid electrolyte layer (I), the method comprising:
preparing a solid electrolyte sheet including a porous substrate and a solid electrolyte held in the porous substrate;
preparing a positive electrode having one surface covered with a solid electrolyte;
preparing a negative electrode having one surface covered with a solid electrolyte;
bonding the positive electrode to one surface of the solid electrolyte sheet in such a manner that the solid electrolyte covering the positive electrode is in contact with the one surface of the solid electrolyte sheet; and
bonding the negative electrode to the other surface of the solid electrolyte sheet in such a manner that the solid electrolyte covering the negative electrode is in contact with the other surface of the solid electrolyte sheet, wherein
the solid electrolyte sheet, the solid electrolyte covering the positive electrode, and the solid electrolyte covering the negative electrode are pressurized to form the solid electrolyte layer in such a manner that an outer periphery of an end portion of the solid electrolyte layer (I) protrudes from an end portion of the positive electrode or the negative electrode by 1 μm to 1 mm in a plan view.

8. The method for producing an all-solid-state battery according to claim 7, wherein the bonding of the positive electrode and the bonding of the negative electrode are performed in such a manner that the solid electrolyte sheet protrudes from the end portion of the positive electrode and the negative electrode in a plan view.
